(19) United States
(12) Patent Application Publication
(10) Pub. No.: US 2026/0066406 A1
(43) Pub. Date: Mar. 5, 2026

(54) SECONDARY BATTERY WITH INTERNAL PRESSURE RELIEF BATTERY CAN

(71) Applicant: SAMSUNG SDI CO., LTD., Yongin-si (KR)

(72) Inventor: Minhyung GUEN, Yongin-si (KR)

(21) Appl. No.: 19/072,012

(22) Filed: Mar. 6, 2025

(30) Foreign Application Priority Data
Aug. 28, 2024 (KR) 10-2024-0116056

(51) Int. Cl. H01M 50/136; H01M 50/103; H01M 50/133

(52) U.S. Cl. CPC H01M 50/136; H01M 50/103; H01M 50/133

(57) ABSTRACT

A battery can of a secondary battery includes a pair of long side portions spaced apart from each other, a pair of short side portions integral with end portions of the pair of long side portions, each of the pair of short side portions including a buffer zone, a bottom portion integral with lower portions of the pair of long side portions and the pair of short side portions, and an internal space surrounded by the pair of short side portions and the pair of long side portions, the internal space accommodating an electrode assembly, and the buffer zone being configured to expand outward in response to an increased internal pressure in the internal space.

### CROSS-REFERENCE TO RELATED APPLICATION

The present application claims priority to and the benefit of Korean Patent Application No. 10-2024-0116056, filed on Aug. 28, 2024, in the Korean Intellectual Property Office, the entire disclosure of which is incorporated herein by reference.

### BACKGROUND

### 1. Field

The present disclosure relates to a secondary battery, and more particularly, to a secondary battery with an internal pressure relief battery can for minimizing the effect of swelling by dispersing internal pressure when the internal pressure rises due to gas generation inside the cell.

### 2. Description of the Related Art

Unlike primary batteries that cannot be (re)charged, secondary batteries are capable of being recharged and discharged. Low-capacity batteries may be used in small and portable electronic devices such as smartphones, feature phones, notebook computers, digital cameras, and camcorders, and large-capacity batteries may be used as motor driving power sources and power storage batteries in hybrid vehicles, electric vehicles, etc. Such batteries include electrode assemblies including a positive electrode and a negative electrode, cases (or cans) that accommodate the electrode assemblies, and electrode terminals connected to the electrode assemblies.

In addition, a plurality of batteries may be combined to form an energy storage device with an expanded voltage and/or current capacity. The category of energy storage devices may include battery modules/packs used in automobiles or electrical appliances.

The above information disclosed in this Background section is for enhancement of understanding of the background of the present disclosure, and therefore, it may contain information that does not constitute a related (or prior) art.

### SUMMARY

According to an aspect of the present disclosure, an internal pressure relief battery can for a prismatic secondary battery includes a pair of rectangular long side portions spaced apart from each other, short side portions integrally formed with both end portions of the long side portions, and a bottom portion integrally formed with a lower portion of the long side portions and the short side portion, and provides an internal space that accommodates an electrode assembly, wherein the short side portion includes a buffer zone, which expands outward under an action of pressure when the pressure in the internal space rises, to prevent swelling of the long side portion.

According to another aspect of the present disclosure, an internal pressure relief battery can for a prismatic secondary battery includes a pair of long side portions spaced apart from each other, short side portions integrally formed with both end portions of the long side portions, and a bottom portion integrally formed with lower end portions of the long side portions and the short side portion, and provides an internal space that accommodates an electrode assembly, wherein the bottom portion has a shape recessed toward an internal space side, a buffer zone which expands outward under an action of pressure when the pressure in the internal space rises and disperses the expansion force of the long side portion, and a notch portion which surrounds the buffer zone.

According to still another aspect of the present disclosure, an internal pressure relief battery can for a prismatic secondary battery includes a pair of long side portions spaced apart, short side portions integrally formed with both end portions of the long side portions, and a bottom portion integrally formed with lower end portions of the long side portions and the short side portion, and provides an internal space that accommodates an electrode assembly, wherein the short side portion includes a buffer zone, which expands outward under an action of pressure when the pressure in the internal space rises, to prevent swelling of the long side portion, and the bottom portion has a shape recessed toward an internal space side, a buffer zone which expands outward under an action of pressure when the pressure in the internal space rises and disperses the expansion force of the long side portion, and a notch portion which surrounds the buffer zone.

### BRIEF DESCRIPTION OF THE DRAWINGS

Features will become apparent to those of skill in the art by describing in detail exemplary embodiments with reference to the attached drawings, in which:

FIG. 1 is an upper perspective view illustrating an exterior of a prismatic battery;

FIG. 2 is a cross-sectional view along line A-A in FIG. 1;

FIG. 3 is a perspective view of an exterior of a secondary battery on which an insulating tape is attached;

FIG. 4 is an exemplary view of a battery module in which batteries are disposed;

FIG. 5 is an exemplary view of a secondary battery pack including a secondary battery module;

FIG. 6 is a conceptual view illustrating the secondary battery pack of FIG. 5 installed in a vehicle;

FIG. 7 is a perspective view of an internal pressure relief battery can for a prismatic secondary battery according to an embodiment of the present disclosure;

FIG. 8 is a cross-sectional view of the battery can illustrated in FIG. 7;

FIG. 9 is a cross-sectional view illustrating a modified example of the battery can of FIG. 8;

FIG. 10 is a cross-sectional view illustrating another modified example of the battery can according to an embodiment of the present disclosure;

FIG. 11 is a cross-sectional view illustrating a modified example of the battery can illustrated in FIG. 10;

FIG. 12 is a view for describing features of a bottom portion of the battery can according to an embodiment of the present disclosure;

FIG. 13 is a cross-sectional view illustrating a modified example of the bottom portion of FIG. 12;

FIGS. 14 to 17 are cross-sectional views illustrating modified examples of the battery can according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

It will also be understood that if an element or layer is referred to as being “linked to,” “connected to,” or “coupled to” another element or layer, it may be directly linked, connected, or coupled to the other element or layer or one or more intervening elements or layers may also be present. When an element or layer is referred to as being “directly linked to,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

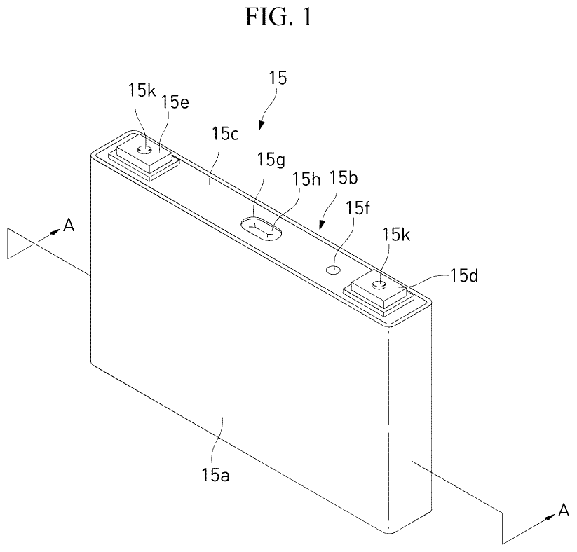

FIG. 1 is a top perspective view of a secondary battery with a can according to the present disclosure.

Referring to FIG. 1, a can 15a defines an overall appearance of the prismatic secondary battery, and may be made of a conductive metal, such as aluminum, aluminum alloy, or nickel-plated steel. In addition, the can 15a may provide a space for accommodating an electrode assembly therein.

A cap assembly 15b may include a cap plate 15c that covers the opening of the can 15a. In some examples, both the can 15a and the cap plate 15c may be made of a conductive material. Here, a first terminal 15d and a second terminal 15e may be electrically connected to respective positive and negative (or negative and positive) electrodes inside the can 15a, and may be installed to protrude outward through the cap plate 15c.

The cap plate 15c may be equipped with an electrolyte injection port 15f formed to install a sealing plug (e.g., a seal pin). A vent 15h, i.e., a degassing device, may be joined to a gas discharging hole 15g. The vent 15h is for discharging gas generated inside the secondary battery.

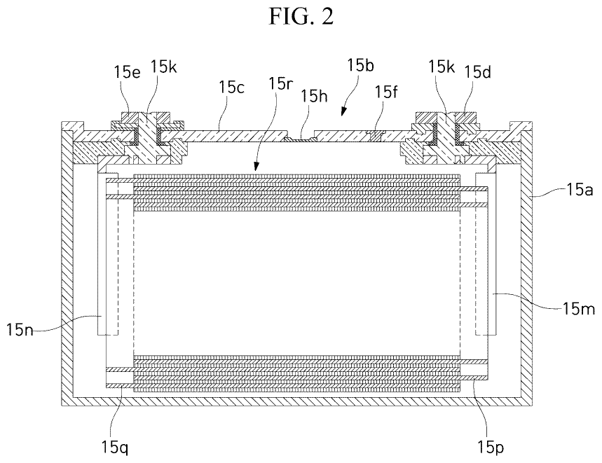

FIG. 2 is a cross-sectional view taken along line A-A of FIG. 1, according to some embodiments of the present disclosure. With reference to FIG. 2, the internal structure of the prismatic secondary battery and the coupling structure with the cap assembly 15b will be further described.

Referring to FIG. 2, an electrode assembly 15r may be formed by winding or stacking a stack of a first electrode plate, a separator, and a second electrode plate, which are formed as thin plates or films. For example, when the electrode assembly 15r is a wound stack, a winding axis may be parallel to the longitudinal direction of the can 15a. In another example, the electrode assembly 15r may be a stack type rather than a winding type. In yet another example, the electrode assembly 15r may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the can (e.g., a case), and any suitable number of electrode assemblies may be accommodated in the case. The first electrode plate of the electrode assembly may act as a negative electrode, and the second electrode plate may act as a positive electrode, e.g., the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 15p (e.g., a first uncoated portion) that is a region to which the first electrode active material is not applied. The first electrode tab 15p may act as a current flow path between the first electrode plate and a first current collector 15m. In some embodiments, when the first electrode plate is manufactured, the first electrode tab 15p is formed by being cut in advance to protrude to one side of the electrode assembly 15r, or the first electrode tab 15p protrudes to one side of the electrode assembly 15r more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 42. In some embodiments, the second electrode tab 15q may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator prevents or substantially reduces instances of a short circuit between the first electrode and the second electrode while allowing movement of lithium ions therebetween. The separator may be made of, e.g., a polyethylene film, a polypropylene film, a polyethylene-polypropylene film, or the like.

In some embodiments, the electrode assembly 15r is accommodated in the case 15a along with an electrolyte.

In the electrode assembly 15r, the first current collector 15m and the second current collector 15n may be welded and connected to the first electrode tab 15p extending from the first electrode plate and the second electrode tab 15q extending from the second electrode plate, respectively.

As illustrated in FIG. 2, the first current collector 15m and the second current collector 15n are connected to the first terminal 15d and the second terminal 15e through connection members 15k, respectively. For example, the connection members 15k may each have an outer peripheral surface that is threaded, and may be fastened to the first terminal 15d and the second terminal 15e by screwing. In another example, the connection members 15k may also be coupled to the first terminal 15d and the second terminal 15e by riveting or welding.

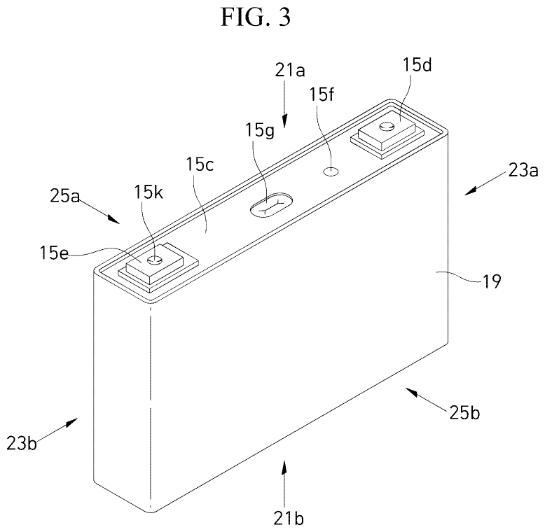

FIG. 3 is a perspective view of an exterior of a secondary battery, on which an insulating tape 19 is attached, and is for defining names of six surfaces of the prismatic secondary battery illustrated in FIG. 1. The secondary battery illustrated in FIG. 3 is hexahedral as a whole and may include a first long side portion 25a and a second long side portion 25b opposite to each other, a first short side portion 23a and a second short side portion 23b opposite to each other, and an upper surface 21a and a lower surface 21b opposite to each other.

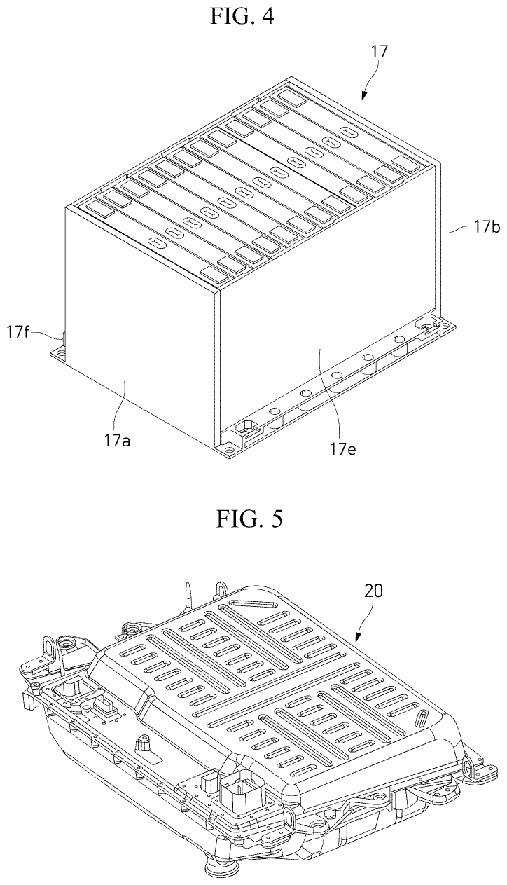

FIG. 4 is a perspective view of a secondary battery module in which secondary batteries are arranged according to embodiments of the present disclosure. With the increase in secondary battery capacity for driving electric vehicles or the like, a secondary battery module may be manufactured by arranging a plurality of secondary battery cells (e.g., a plurality of the secondary battery illustrated in FIG. 1) transversely and/or longitudinally and connecting them together. The plurality of secondary batteries may be arranged in a space defined by a pair of facing end plates 17a and 17b and a pair of facing side plates 17e and 17f. The secondary batteries may be arranged in any suitable arrangement (direction) and number to obtain desired voltage and current specifications.

FIG. 5 is a perspective view of a battery pack 20 according to embodiments of the present disclosure. Referring to FIG. 5, the battery pack 20 may include an assembly to which individual batteries are electrically connected and a pack housing accommodating the same. In the drawings, for convenience of illustration, components including a bus bar, a cooling unit, external terminals for electrically connecting batteries, etc., are not shown. The battery pack 20 may be mounted on (or in) a vehicle. The vehicle may be, e.g., an electric vehicle, a hybrid vehicle, or a plug-in hybrid vehicle. The vehicle may be, e.g., a four-wheeled vehicle or a two-wheeled vehicle.

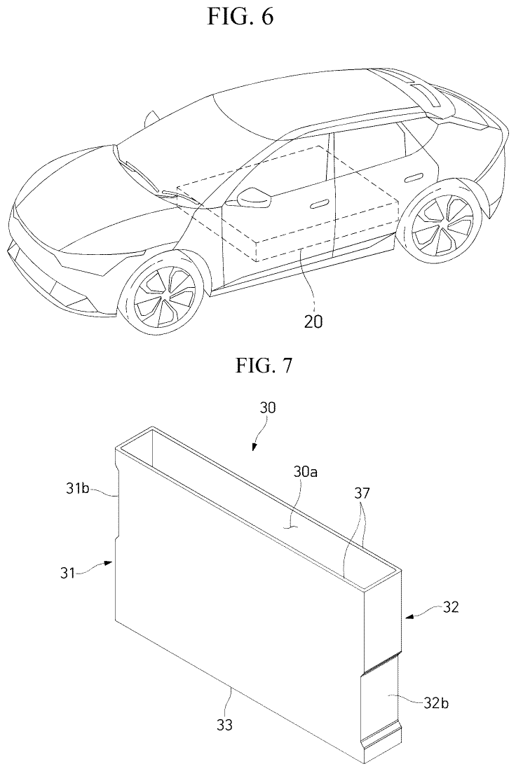

FIG. 6 shows a vehicle that includes the battery pack 20 shown in FIG. 5 on the lower body thereof. The vehicle may operate by (e.g., may be powered by) receiving power from the battery pack 20.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L¹ may be Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material may be in a range of about 90 wt % to about 99.5 wt % on the basis of 100 wt % of the positive electrode active material layer, and the content of the binder and the conductive material may be in a range of about 0.5 wt % to about 5 wt %, respectively, on the basis of 100 wt % of the positive electrode active material layer.

The substrate may be aluminum (Al).

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, e.g., crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt. The non-aqueous organic solvent acts as a medium through which ions involved in the electrochemical reaction of the battery can move. The non-aqueous organic solvent may be a carbonate, an ester, an ether, a ketone, an alcohol solvent, an aprotic solvent, and may be used alone or in combination of two or more. In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto. The organic material and the inorganic material may be mixed in one coating layer or may be in the form of a coating layer including (or containing) an organic material and a coating layer including (or containing) an inorganic material that are stacked on each other.

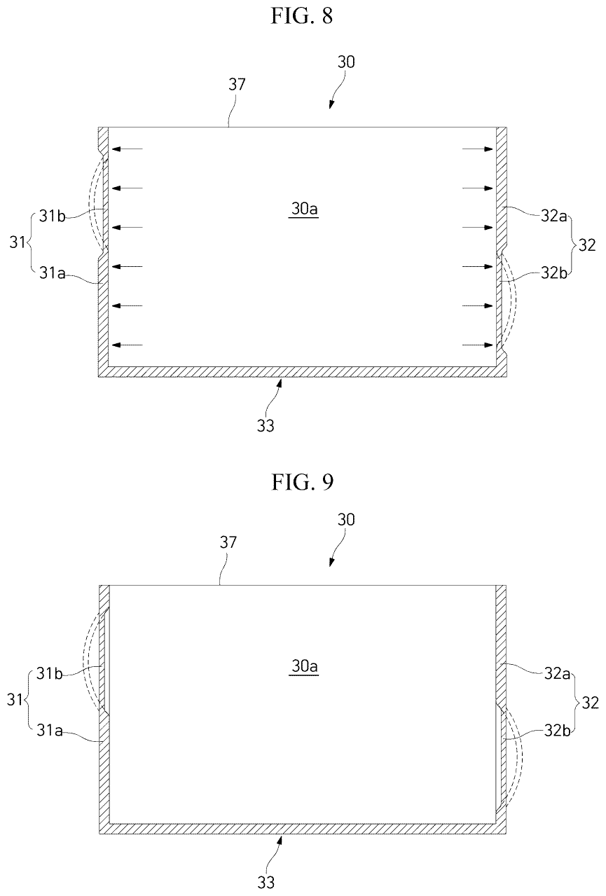

FIG. 7 is a perspective view of an internal pressure relief battery can for a prismatic secondary battery according to an embodiment of the present disclosure. FIG. 8 is a cross-sectional view of a battery can 30 illustrated in FIG. 7. For example, the battery can 30 in FIGS. 7-8 may be an enlarged and detailed illustration of the can 15a in FIG. 1.

As illustrated in FIGS. 7 and 8, the battery can 30 according to the present embodiments may include long side portions 37 between which the electrode assembly is inserted, first and second short side portions 31 and 32, a bottom portion 33, and a buffer zone. As described below, the buffer zone is a portion of the battery can 30 and may be an area for alleviating excessive expansion of the first long side portion 25a in FIG. 3 and the second long side portion 25b in FIG. 3 due to swelling of the battery.

The long side portions 37 may be rectangular members having a certain thickness and spaced apart from each other in parallel. In addition, the first and second short side portions 31 and 32 may be integrated (e.g., connected) with both end portions of the long side portion 37, and the bottom portion 33 may be integrated (e.g., connected) with lower end portions of the long side portions 37 and the first and second short side portions 31 and 32. For example, referring to FIG. 7, the first and second short side portions 31 and 32 may be integral with the long side portions 37 (e.g., formed of a same material and same process into a monolithic and seamless structure), and the bottom portion 33 may be integral with the long side portions 37 and the first and second short side portions 31 and 32. The long side portions 37, the first and second short side portions 31 and 32, and the bottom portion 33 may be sidewalls and a bottom of the can 30, and may be arranged into a volumetric container with an internal space 30a therein, such that one side of the can 30 (e.g., one side of the hexahedral structure) may be open, e.g., upward. An electrode assembly, an electrolyte, etc. may be accommodated in the internal space 30a. In addition, a cap assembly may be mounted on the long side portions 37 of the battery can 30.

The first short side portion 31 and the second short side portion 32 may be located opposite to each other with the internal space 30a therebetween, and may face each other. For example, referring to FIG. 7, the internal space 30a may be surrounded by the long side portions 37 and the first and second short side portions 31 and 32.

In some embodiments, the first short side portion 31 may be provided with a fixed surface 31a and a buffer surface 31b. The fixed surface 31a may be a portion that is hardly deformed (e.g., a rigid portion) when the internal pressure of the internal space 30a increases due to swelling, e.g., the fixed surface 31a may be static and not deformable by the internal pressure. That is, even when the internal pressure of the internal space 30a increases, the initial state of the fixed surface 31a may be maintained without expanding outward. The buffer surface 31b may exhibit elasticity (e.g., due to reduced thickness) and may expand outward under an action of the internal pressure when the internal pressure increases. The buffer surface 31b may expand outward to disperse the expansion force of the long side portions.

In the case of the first short side portion 31, the fixed surface 31a may be located on a lower side and the buffer surface 31b may be located on an upper side (e.g., the fixed surface 31a may be between the bottom portion 33 and the buffer surface 31b). A thickness of the fixed surface 31a (e.g., in a direction parallel to the bottom portion 33) may be greater than a thickness of the buffer surface 31b (e.g., in a direction parallel to the bottom portion 33). A thickness ratio of the fixed surface 31a and the buffer surface 31b may vary, and the thickness of the buffer surface 31b may be 50% or less of the thickness of the fixed surface 31a. For example, referring to FIG. 8, inner surfaces of the fixed surface 31a and the buffer surface 31b may face the internal space 30a and may be level with each other, and outer surfaces of the fixed surface 31a and the buffer surface 31b may face away from the internal space 30a and may be offset relative to each other. For example, referring to FIG. 8, inner surfaces of the fixed surface 32a and the buffer surface 32b may face the internal space 30a and may be level with each other, and outer surfaces of the fixed surface 32a and the buffer surface 32b may face away from the internal space 30a and may be offset relative to each other.

In some other embodiments, a fixed surface 32a and a buffer surface 32b may be formed on the second short side portion 32. The fixed surface 32a may be a portion that does not deform (e.g., a rigid portion) even when pressure is applied when the internal pressure of the can 30 increases, e.g., the fixed surface 32a may be static and not deformable by the internal pressure. In addition, the buffer surface 32b may be a portion that may exhibit elasticity (e.g., due to reduced thickness) and may expand outward under the action of (e.g., in response to) pressure when the internal pressure increases. In the case of the second short side portion 32, the fixed surface 32a may be located on the upper side and the buffer surface 32b may be located on the lower side (e.g., the buffer surface 32b may be between the bottom portion 33 and the fixed surface 32a).

The buffer surfaces 31b and 32b in the first short side portion 31 and the second short side portion 32 may constitute the buffer zones that expand outward under the action of pressure when the pressure in the internal space rises and disperse the expansion force of the long side portions 37. As described above, as the buffer surface 31b in the first short side portion 31 is located on the upper side and the buffer surface 32b in the second short side portion 32 is located on the lower side, the buffer surface 31b of the first short side portion 31 and the buffer surface 32b of the second short side portion 32 may be located in a diagonal direction, e.g., the buffer surface 31b and the buffer surface 32b may be arranged along a diagonal direction with respect to a center of the can. Thus, the buffer zones may be symmetrical to each other (e.g., with respect to a center of the can 30).

In some embodiments, the buffer surface 31b of the first short side portion 31 and the buffer surface 32b of the second short side portion 32 may have the same thickness and area. In addition, the fixed surface 31a of the first short side portion 31 and the fixed surface 32a of the second short side portion 32 may also have the same thickness and area.

The buffer surfaces 31b and 32b may be formed by press processing of the metal plate for forming the can 30. For example, the buffer surfaces 31b and 32b may be formed before the material for manufacturing the can 30, i.e., the metal plate, is bent. In another example, the buffer surfaces 31b and 32b may be formed after the can 30 is made.

As described above, the buffer surfaces 31b and 32b may be disposed in a diagonal direction (e.g., a diagonal arrangement), and the fixed surfaces 31a and 32a may be disposed in a diagonal direction (e.g., a diagonal arrangement) opposite to that of the buffer surfaces 31b and 32b. Accordingly, the rigidity of the can 30 may be maintained during swelling deformation and the electrode plate mounted in the internal space may be prevented from tilting to one side.

In some embodiments, as illustrated in FIG. 9, the buffer surfaces 31b and 32b may be formed on the inner surface (surface that faces the internal space 30a) of the first and second short side portions 31 and 32 (e.g., outer surfaces of the fixed surface 31a and the buffer surface 31b may face away from the internal space 30a and may be level with each other, and outer surfaces of the fixed surface 32a and the buffer surface 32b may face away from the internal space 30a and may be level with each other). In the case of the can 30 according to the embodiment illustrated in FIG. 8, the buffer surfaces are formed on outer surfaces of the first and second short side portions 31 and 32, but, as long as the buffer surfaces perform a swelling function under the action of internal pressure, the buffer surfaces may be formed on inner surfaces of the first and second short side portions.

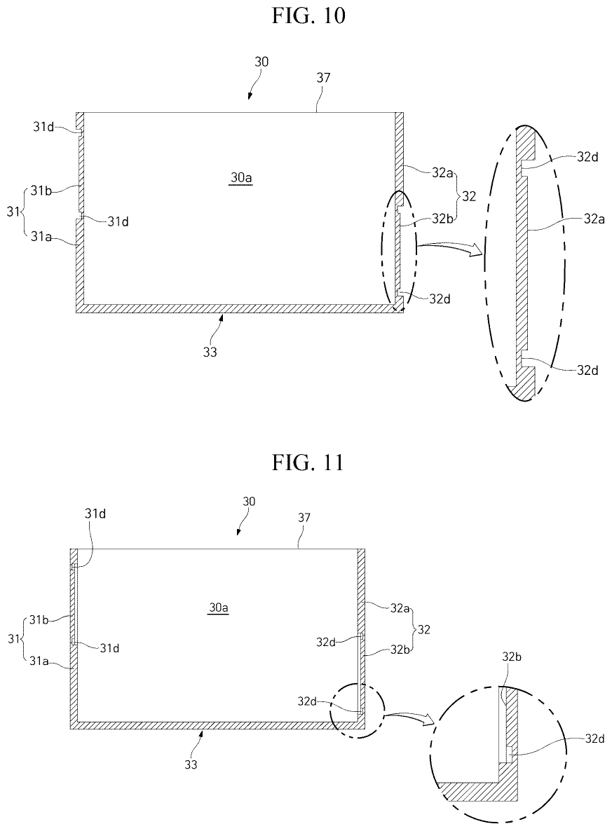

FIG. 10 is a cross-sectional view illustrating another modified example of the battery can 30 according to an embodiment of the present disclosure. The can 30 illustrated in FIG. 10 includes buffer surfaces 31b and 32b formed on the outer surfaces of the first and second short side portions.

As illustrated in FIG. 10, the buffer surface 31b may be formed on an upper side of the first short side portion 31 and the fixed surface 31a may be formed on a lower side of the first short side portion 31, and side notches 31d may be formed at upper and lower end portions of the buffer surface 31b. Among the two side notches 31d, the lower side notch 31d may be located (e.g., positioned) between the buffer surface 31b and the fixed surface 31a. The side notches 31d may act to more easily implement the swelling function of the buffer surface 31b.

In addition, in the case of the second short side portion 32, the fixed surface 32a may be on the upper side, and a buffer surface 32b may be on the lower side. In addition, side notches 32d may be provided at the upper and lower end portions of the buffer surface 32b. Among the two side notches 32d, the side notch 32d located on the upper side may be located between the buffer surface 32b and the fixed surface 32a. The upper and lower side notches 32d may act to more easily implement the swelling function of the buffer surface 32b.

FIG. 11 is a cross-sectional view illustrating another modified example of the battery can 30 according to an embodiment of the present disclosure. The can 30 illustrated in FIG. 11 is a type in which the buffer surfaces 31b and 32b of the first and second short side portions 31 and 32 are formed on the inner side and may have the side notches 31d and 32d at the upper and lower end portions of each of the buffer surfaces 31b and 32b.

Referring to FIG. 11, the side notches 31d formed in the first short side portion 31 may be formed at the upper and lower end portions of the buffer surface 31b. Among the side notches 31d at the upper and lower end portions, the lower side notch 31d may be located between the buffer surface 31b and the fixed surface 31a.

In addition, the side notches 32d provided in the second short side portion 32 may be located at the upper and lower end portions of the buffer surface 32b. Among the two side notches 32d, the upper side notch 32d may be formed between the fixed surface 32a and the buffer surface 32b.

As described above, by applying a buffer zone to the first short side portion 31 and the second short side portion 32, the expansion of the long side portion may be alleviated when the battery swells. This will be further described as follows.

During use of the battery cells, pressure inside the can may increase, and the long side portions 37 may be the portion most affected by the increased pressure. For example, excessive expansion of the long side portions 37 may press neighboring cells in the battery module, causing the neighboring cells to move out of their normal positions. This may potentially cause a malfunction by pushing a cell that is operating normally. In order to prevent or substantially minimize swelling of the long side portions 37, the first and second short side portions 31 and 32 may be configured to expanded to disperse the expansion force of the long side portions 37.

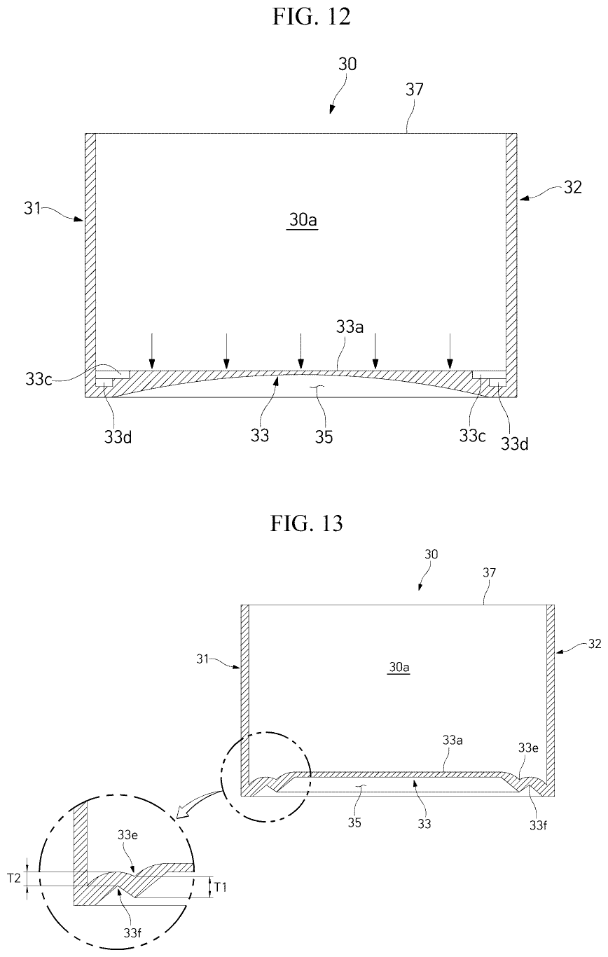

FIG. 12 is a view for describing features of the bottom portion 33 of the battery can according to an embodiment of the present disclosure.

As illustrated in FIG. 12, the bottom portion 33 may have a shape recessed toward the internal space 30a (e.g., the bottom portion 33 may have a gradually decreasing thickness toward the center of the bottom portion 33 along a direction parallel to the first and second side portions 31 and 32). By having such a recessed shape, a lower space 35 may be formed under the bottom portion 33. The lower space 35 may be a space in which the buffer zone, i.e., a buffer surface 33a, may expand downward. In FIG. 12, the buffer surface 33a has a shape with a curved lower surface, but the shape of the buffer surface 33a may vary.

In the battery can 30, a buffer zone, which expands outward under the action of pressure when the pressure in the internal space rises, may be formed to prevent swelling of the long side portion. Further, first and second notch portions 33c and 33d that surround the buffer zone may be formed in the bottom portion 33.

The buffer zone may be a buffer surface 33a having a relatively small average thickness compared to the long side portions 37. The buffer surface 33a may be a portion of the bottom portion 33. The bottom portion 33 may include the buffer surface 33a and the first and second notch portions 33c and 33d. The first and second notch portions 33c and 33d may be formed in the outer portion of the buffer surface 33a (e.g., at opposite edges of the bottom portion 33).

Since the buffer surface 33a expands before the long side portions 37 swell when the internal pressure increases, the buffer surface 33a may have a thickness smaller than the thicknesses of the long side portions 37. The shape of the buffer surface 33a may vary.

In addition, the first and second notch portions 33c and 33d may act to more easily implement the expanding function of the buffer surface 33a. As illustrated in FIG. 12, the first notch portion 33c and the second notch portion 33d may take the form of steps.

The first notch portion 33c may be located on the outer side of the buffer surface 33a and may have a step with respect to the buffer surface 33a. In addition, the second notch portion 33d may be formed on the outer side of the first notch portion 33c and may have a step with respect to the first notch portion 33c. Additionally, the second notch portion 33d may be integrally connected to the lower ends of the long side portions 37 and the first and second short side portions 31 and 32. In another example, the first notch portion 33c and the second notch portion 33d may take the form of a trench-shaped groove surrounding the buffer surface 33a and may act to allow the buffer surface 33a to expand downward more easily

FIG. 13 is a cross-sectional view illustrating a modified example of the bottom portion 33 of FIG. 12.

Referring to FIG. 13, the can 30 may have the lower space 35 under the bottom portion 33. The lower space 35 may be a space that accommodates the buffer surface 33a when the buffer surface 33a expands downward. The buffer surface 33a included in the bottom portion 33 may have a certain thickness. The thickness of the buffer surface 33a may be about 0.4 mm.

In addition, a first notch portion 33e and a second notch portion 33f may be formed in the outer (e.g., peripheral) portion of the buffer surface 33a. The first notch portion 33e may be formed in the outer portion of the buffer surface 33a and may have a shape that is bent downward. A cross-section of the first notch portion 33e may have an approximately V-shape. The second notch portion 33f may be located in the outer portion of the first notch portion 33e and may have a shape that is bent upward. The second notch portion 33f may have an approximately inverted V-shape.

In addition, a thickness T2 of the second notch portion 33f may be relatively smaller than a thickness T1 of the first notch portion 33e. A thickness ratio of the first notch portion 33e and the second notch portion 33f may vary. The thickness T1 of the first notch portion 33e may be about 0.7 mm and the thickness T2 of the second notch portion 33f may be about 0.5 mm.

The first notch portion 33e and second notch portion 33f may surround the buffer surface 33a and may act to allow the buffer surface 33a to expand downward more easily when the internal pressure of the can rises.

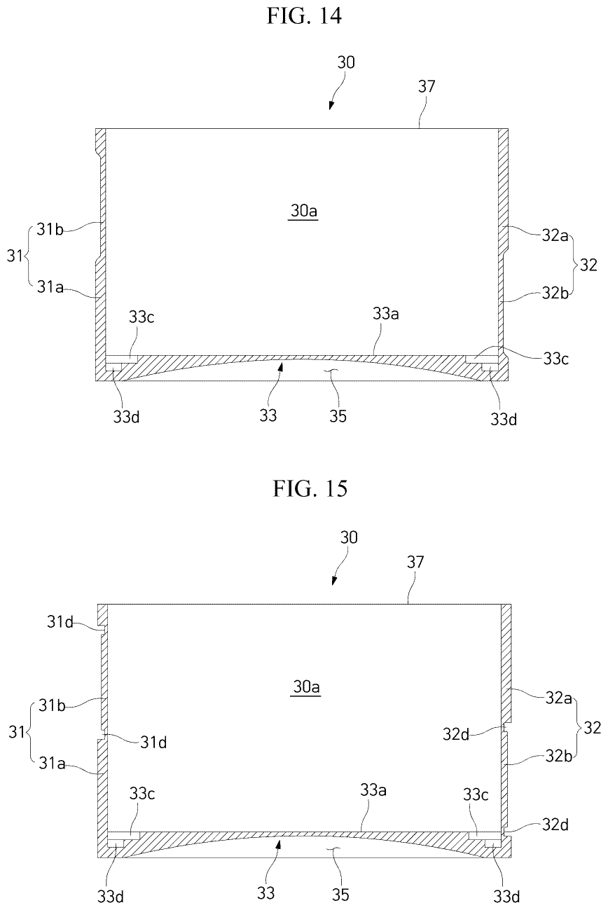

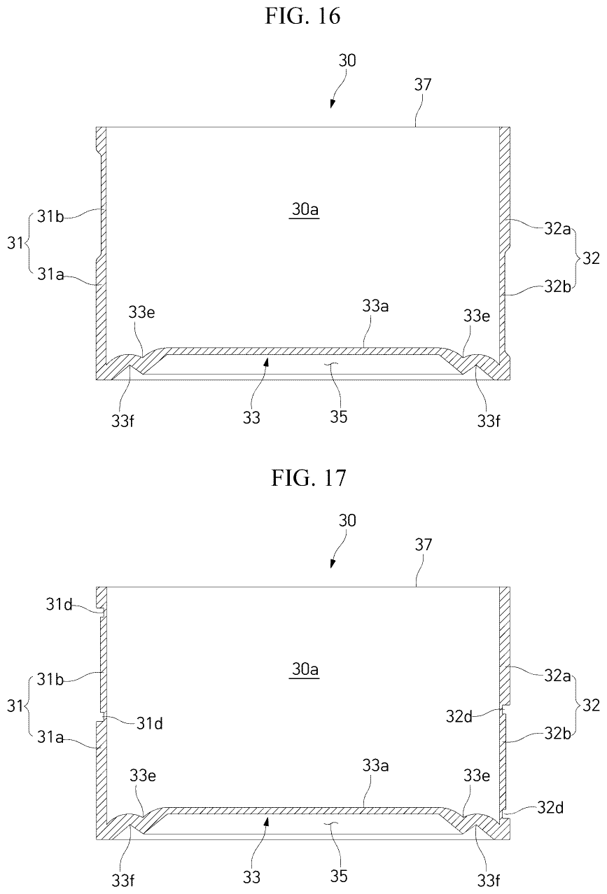

FIGS. 14 to 17 are cross-sectional views illustrating modified examples of the battery can according to an embodiment of the present disclosure.

The can 30 illustrated in FIGS. 14 and 17 is a type of can in which the buffer surfaces 31b, 32b, and 33a may be applied simultaneously and in various combinations to both the first and second short side portions 31 and 32 and the bottom portion 33. Since the description of the buffer surfaces 31b, 32b, and 33a has been described above, repeated description thereof will be omitted. By applying the buffer surfaces 31b, 32b, and 33a to all of the first and second short side portions 31 and 32 and the bottom portion 33, excessive expansion of the long side portions 37 may be more completely prevented because three buffer zones are acting. Additionally, since the side notches 31d and 32d are added to the upper and lower surfaces of the buffer surfaces 31b and 32b in the can 30 of FIGS. 15 and 17, the swelling function of the first and second short side portions 31 and 32 may be more easily performed.

By way of summation and review, although prismatic batteries among secondary batteries have high space utilization and stability, their internal pressure may rise during use, which can cause deformation of the battery can, i.e., swelling. Swelling may cause battery performance degradation and safety issues. Attempts have been made to use various materials and designs to prevent swelling. However, a battery can which improves the safety and performance of a battery and can be used more reliably is desired.

The present disclosure is directed to providing an internal pressure relief battery in which a space expands toward both short sides and a bottom of the cell when the internal pressure of the cell rises, thereby improving the safety and performance of a battery by minimizing expansion in the thickness direction due to swelling. That is, as the internal pressure is dispersed toward both short sides and the bottom of the cell when the internal pressure of the cell rises, excessive expansion of the long side portions may be prevented or substantially minimized, thereby improving the safety and performance of the battery.

Aspects and features of the present disclosure are not limited to those described above, and other aspects and features not specifically mentioned herein will be clearly understood by those skilled in the art from the description of the disclosure above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery can of a secondary battery, the battery can comprising:
a pair of long side portions spaced apart from each other;
a pair of short side portions integral with end portions of the pair of long side portions, each of the pair of short side portions including a buffer zone;
a bottom portion integral with lower portions of the pair of long side portions and the pair of short side portions; and
an internal space surrounded by the pair of short side portions and the pair of long side portions, the internal space accommodating an electrode assembly, and the buffer zone being configured to expand outward in response to an increased internal pressure in the internal space.

2. The battery can as claimed in claim 1, wherein:
the pair of short side portions includes a first short side portion and a second short side portion which face each other with the internal space therebetween, and
the buffer zone in the first short side portion and the buffer zone in the second short side portion are symmetrical to each other.

3. The battery can as claimed in claim 2, wherein each of the first short side portion and the second short side portion includes a fixed surface and a buffer surface, the fixed surface being not deformable by the internal pressure, and the buffer surface being the buffer zone.

4. The battery can as claimed in claim 3, wherein the buffer surface of the first short side portion and the buffer surface of the second short side portion are positioned in a diagonal direction.

5. The battery can as claimed in claim 3, wherein the buffer surface of the first short side portion and the buffer surface of the second short side portion have a same thickness and a same area.

6. The battery can as claimed in claim 3, further comprising a side notch between the buffer surface and the fixed surface in each of the first short side portion and the second short side portion.

7. The battery can as claimed in claim 3, wherein a thickness of the buffer surface is 50% or less of a thickness of the fixed surface in each of the first short side portion and the second short side portion.

8. A battery can of a secondary battery, the battery can comprising:
a pair of long side portions spaced apart from each other;
a pair of short side portions integral with end portions of the pair of long side portions;
a bottom portion integral with lower portions of the pair of long side portions and the pair of short side portions, the bottom portion including a buffer zone having a recessed shape and a notch portion which surrounds the buffer zone; and
an internal space surrounded by the pair of short side portions, the pair of long side portions, and the bottom portion, the internal space accommodating an electrode assembly, and the buffer zone being configured to expand outward in response to an increased internal pressure in the internal space.

9. The battery can as claimed in claim 8, wherein the buffer zone includes a buffer surface having an average thickness that is smaller than a thickness of each of the pair of long side portions.

10. The battery can as claimed in claim 9, wherein the notch portion is in an outer portion of the buffer surface.

11. The battery can as claimed in claim 8, wherein the notch portion includes:
a first notch portion at an outer portion of a buffer surface and having a step with respect to the buffer surface, and
a second notch portion having a step with respect to the first notch portion and connected to the lower end portions of the pair of long side portions and the pair of short side portions.

12. The battery can as claimed in claim 8, wherein the notch portion includes:
a first notch portion at an outer portion of a buffer surface and bent downward, and
a second notch portion at an outer portion of the first notch and bent upward.

13. The battery can as claimed in claim 12, wherein a thickness of the second notch portion is smaller than a thickness of the first notch portion.

14. A secondary battery with a battery can, the battery can comprising:
a pair of long side portions spaced apart from each other;
a pair of short side portions integral with end portions of the pair of long side portions, each of the pair of short side portions including a side buffer zone;
a bottom portion integral with lower portions of the pair of long side portions and the pair of short side portions, the bottom portion including a bottom buffer zone having a recessed shape and a notch portion which surrounds the bottom buffer zone; and
an internal space surrounded by the pair of short side portions and the pair of long side portions, the internal space accommodating an electrode assembly, and each of the side buffer zone and the bottom buffer zone being configured to expand outward in response to an increased internal pressure in the internal space.

15. The secondary battery as claimed in claim 14, wherein:
each of the pair of short side portions includes a first short side portion and a second short side portion which face each other with the internal space therebetween, and
the side buffer zone of the first short side portion and the side buffer zone of the second short side portion are symmetrical to each other.

16. The secondary battery as claimed in claim 15, wherein each of the first short side portion and the second short side portion includes a fixed surface and a buffer surface, the fixed surface being not deformable by the internal pressure, and the buffer surface being the side buffer zone.

17. The secondary battery as claimed in claim 16, wherein the buffer surface of the first short side portion and the buffer surface of the second short side portion are positioned in a diagonal direction.

18. The secondary battery as claimed in claim 16, further comprising a side notch between the buffer surface and the fixed surface in each of the first short side portion and the second short side portion.

19. The secondary battery as claimed in claim 14, wherein the bottom buffer zone includes a buffer surface having an average thickness that is smaller than a thickness of each of the pair of long side portions.

20. The secondary battery as claimed in claim 19, wherein the notch portion is at an outer portion of the buffer surface.
